(19) United States
(12) Patent Application Publication
(10) Pub. No.: US 2013/0204708 A1
(43) Pub. Date: Aug. 8, 2013

(54) PROVIDING TARGETED OFFERS BASED ON DYNAMIC ATTRIBUTES OF USERS

(71) Applicants: Vidhyaprakash RAMACHANDRAN, Richardson, TX (US); Ashley EVANS, Stonington, CT (US); Paul A. DONFRIED, Richmond, VA (US); Michael POLOSKY, Dallas, TX (US)

(72) Inventors: Vidhyaprakash RAMACHANDRAN, Richardson, TX (US); Ashley EVANS, Stonington, CT (US); Paul A. DONFRIED, Richmond, VA (US); Michael POLOSKY, Dallas, TX (US)

(73) Assignee: VERIZON PATENT AND LICENSING INC., Basking Ridge, NJ (US)

(21) Appl. No.: 13/364,423

(22) Filed: Feb. 2, 2012

(51) Int. Cl. G06Q 30/02; G06F 21/00

(52) U.S. Cl. 705/14.66; 726/27; 705/14.1

(57) ABSTRACT

A server device receives, from a third party device, a question about a behavior of a user. The server device identifies an attribute required to provide an answer to the question, determines whether a profile of the user includes the attribute, and determines the answer based on the attribute when the profile includes the attribute, where the answer does not include any information that identifies the user. The server device also transmits the answer to the third party.

### BACKGROUND

Various entities (e.g., advertisers, retailers, etc.) increasingly seek to provide targeted offers to consumers. However, these entities often lack sufficient information about a consumer in order to provide a targeted offer that would be of-interest to the consumer. Although consumers often like to take advantage of targeted offers, many consumers are reluctant to authorize each individual entity to collect, access, and/or store their private information, including information about their behavior, such as the consumers' purchasing history.

### BRIEF DESCRIPTION OF THE DRAWINGS

FIG. 1 is a diagram of an example environment in which systems and/or methods described herein may be implemented;

FIG. 2 is a diagram of example components of one or more of the devices of FIG. 1;

FIG. 3 is a diagram of example profile information of a user;

FIG. 4 is a diagram of example vetted static attributes that may be provided in the profile information;

FIG. 5 is a diagram of example self-asserted static attributes that may be provided in the profile information;

FIG. 6 is a diagram of example dynamic attributes that may be provided in the profile information;

FIG. 7 is a flow chart of an example process for registering a third party server, according to an implementation described herein;

FIG. 8 is a flow chart of an example process for registering a user, according to an implementation described herein;

FIG. 9 is a flow chart of an example process for providing answers to questions about a user, according to an implementation described herein; and

FIG. 10 is a flow chart of an example process for providing a targeted offer to a user, according to an implementation described herein.

### DETAILED DESCRIPTION OF PREFERRED EMBODIMENTS

The following detailed description refers to the accompanying drawings. The same reference numbers in different drawings may identify the same or similar elements.

As used herein, an attribute may refer to any information associated with a particular person. A dynamic attribute may refer to information associated with behaviors of the user, such as, for example, shopping information, travel information, etc.

Systems and/or methods described herein may provide generic information, based on dynamic attributes of a user, to third parties. In one example, a third party server may request that an attributes server provide an answer to a question about a user. The attributes server may determine the answer based on a dynamic attribute of the user, and may provide the answer to the third party server. The answer may omit data that applies only to the user, such as private information of the user. As a result, the third party server may provide a targeted offer to the user based on the answer without having access to the private information about the user.

As used herein, the term user is intended to be broadly interpreted to include a client device or a user of a client device.

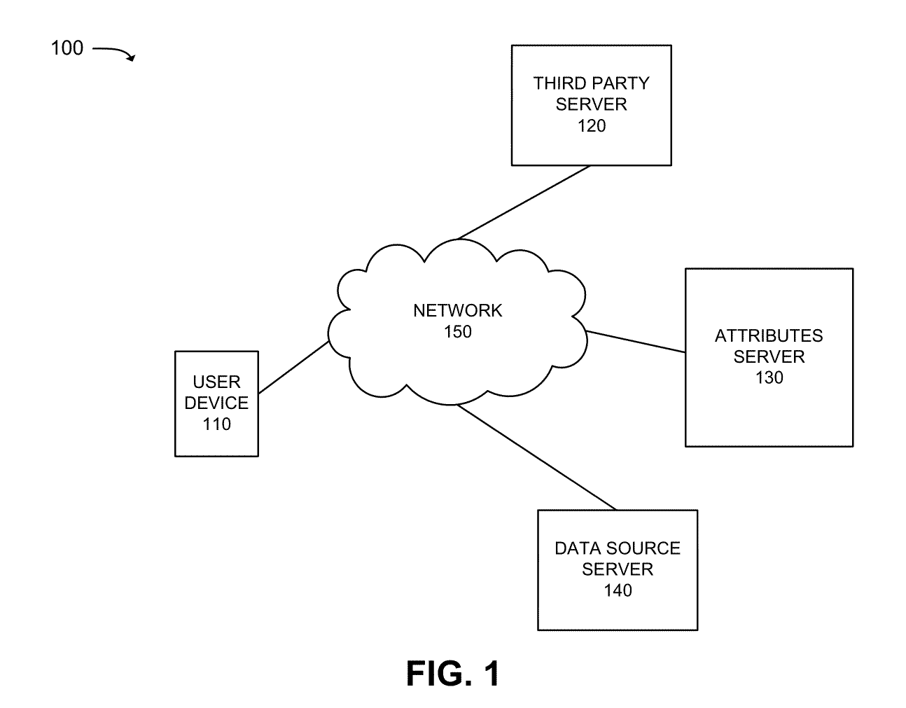

FIG. 1 is a diagram of an example environment 100 in which systems and/or methods described herein may be implemented. As shown in FIG. 1, environment 100 may include a user device 110, a third party server 120, an attributes server 130, a data source server 140, and a network 150. A single user device 110, third party server 120, attributes server 130, data source server 140, and network 150 have been illustrated in FIG. 1 for simplicity. In practice, there may be more user devices 110, third party servers 120, attributes servers 130, data source servers 140, and/or networks 150. Also, in some implementations, one or more of the components of environment 100 may perform one or more functions described as being performed by another one or more of the components of environment 100.

Furthermore, two or more of the components, of FIG. 1, may be implemented within a single device, or a single device may be implemented as multiple, distributed devices. For example, third party server 120 may include data source server 140. Also, components of environment 100 may interconnect via wired and/or wireless connections. In other words, components of environment 100 may communicate via a wired connection, a wireless connection, or a combination of a wired connection and a wireless connection.

User device 110 may include a device that is capable of communicating with attributes server 130 via network 150. In one implementation, user device 110 may include computer, such as a web service terminal, a personal computer, a laptop computer, a handheld computer, etc. Alternatively, or additionally, user device 110 may include a mobile computation and communication device, such as a smart phone, a personal digital assistant (PDA), etc. Alternatively, or additionally, user device 110 may include a set-top box (STB) or any other device capable of transmitting and/or receiving data. User device 110 may allow a user to authorize attributes server 130 to collect information about the user from data source server 140 and to provide answers, based on the collected information, to third party server 120.

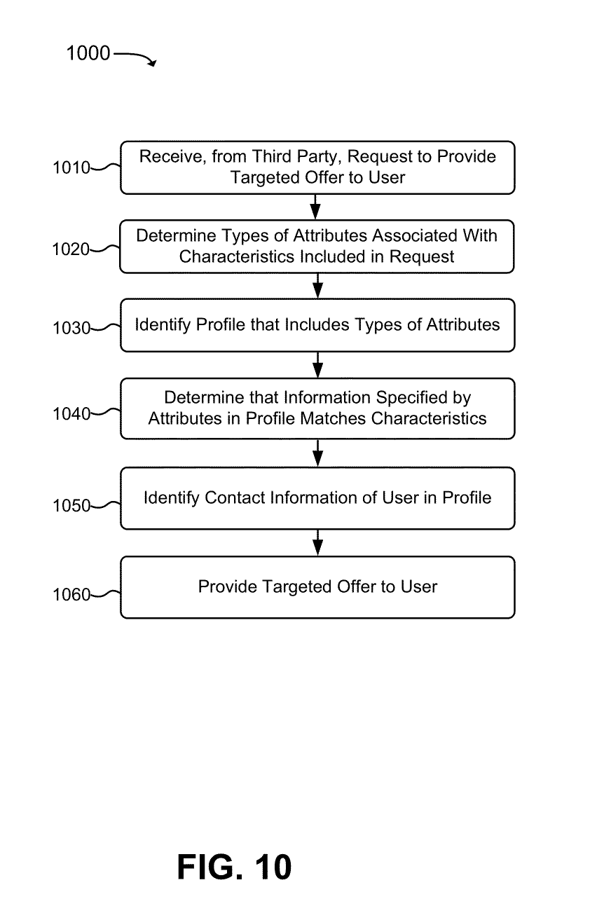

Third party server 120 may include a single server device or a collection of multiple server devices and/or computer systems. In one example, third party server 120 may include a device that is capable of communicating with attributes server 130 and/or data source server 140, via network 150. An entity that provides targeted offers to users may operate and/or manage third party server 120. The entity may include, for example, an advertiser, a coupon provider, a retailer, a service provider, a merchant, etc. In one implementation, third party server 120 may receive answers to questions about a user from attributes server 130. Third party server 120 may provide a targeted offer to the user based on the received answers. Alternatively, or additionally, third party server 120 may request for attributes server 130 to provide the targeted offer to one or more users with particular characteristics, as described further below with reference to FIG. 10.

Attributes server 130 may include a single server device or a collection of multiple server devices and/or computer systems. In one example, attributes server 130 may include a device that is capable of communicating with user device 110, third party server 120, and/or data source server 140, via network 150. In one implementation, a service provider, such as a telecommunications provider, may operate and/or manage attributes server 130. Alternatively, or additionally, an entity trusted by the user, such as, for example, a financial institution of the user, may operate and/or manage attributes server 130.

Data source server 140 may include a single server device or a collection of multiple server devices and/or computer systems. In one example, data source server 140 may include a device that provides information about a user to attributes server 130. In one implementation, an entity selected by a user may operate and/or manage data source server 140. The entity may include, for example, a telecommunication service provider associated with user device 110, a financial institution (e.g., a bank) associated with the user, a retailer, etc. Alternatively, or additionally, an entity associated with third party server 120 may also be associated with data source server 140. Alternatively, or additionally, a third party data provider may operate and/or manage data source server 140. The third party data provider may include, for example, LEXIS NEXIS, CHOICEPOINT, EXPERIAN, etc.

Network 150 may include a single network, multiple networks of a same type, or multiple networks of different types. For example, network 150 may include one or more of a direct connection between devices, a local area network (LAN), a wide area network (WAN) (e.g., the Internet), a metropolitan area network (MAN), a wireless network (e.g., a general packet radio service (GPRS) network), a telephone network (e.g., a Public Switched Telephone Network (PSTN) or a cellular network), a subset of the Internet, an ad hoc network, a fiber optic network, or any combination of the aforementioned networks.

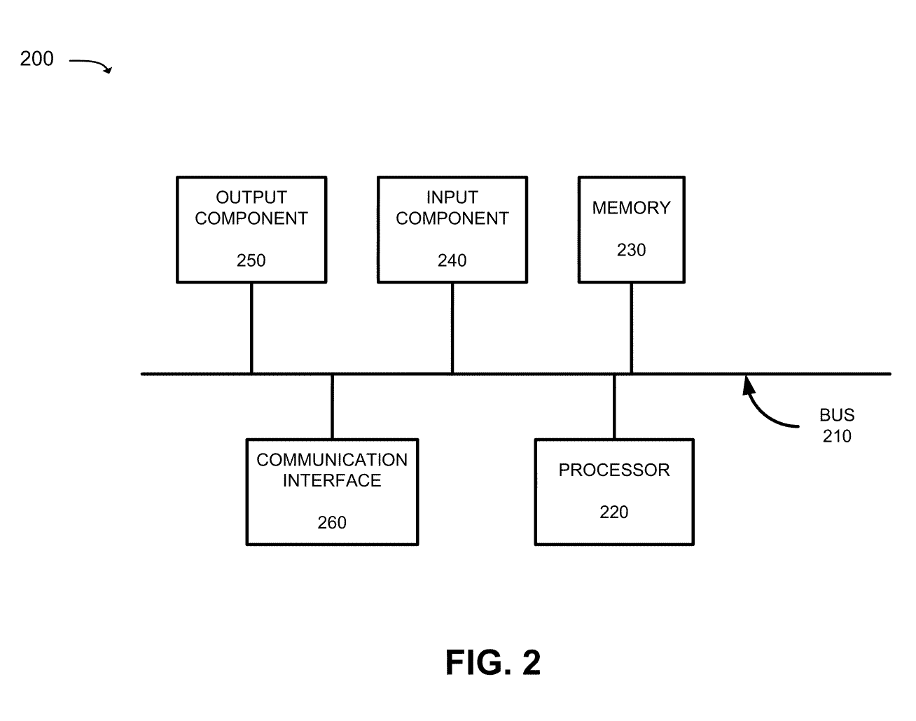

FIG. 2 is a diagram of example components of a device 200 that may correspond to user device 110, third party server 120, attributes server 130, and/or data source server 140. Each one of user device 110, third party server 120, attributes server 130, and/or data source server 140 may include one or more devices 200 and/or one or more components of device 200.

As shown in FIG. 2, device 200 may include a bus 210, a processor 220, a memory 230, an input component 240, an output component 250, and a communication interface 260. In one implementation, device 200 may include additional components, fewer components, different components, and/or differently arranged components than are shown in FIG. 2. Additionally, or alternatively, one or more components of device 200 may perform one or more tasks described as being performed by one or more other components of device 200.

Bus 210 may include a path that permits communication among the components of device 200. Processor 220 may include one or more processors, microprocessors, or processing logic that may interpret and execute instructions. Memory 230 may include any type of dynamic storage device that may store information and instructions for execution by processor 220, and/or any type of non-volatile storage device that may store information for use by processor 220.

Input component 240 may include one or more input mechanisms that permit a user to input information to device 200. Output component 250 may include one or more output mechanisms that output information to the user. Examples of input and output mechanisms may include buttons; a touch screen interface to permit data and control commands to be input into device 200; a speaker to receive electrical signals and output audio signals; a microphone to receive audio signals and output electrical signals; a display to output visual information (e.g., web pages, product information, etc.); etc.

Communication interface 260 may include any transceiver-like mechanism that enables device 200 to communicate with other devices and/or systems. For example, communication interface 260 may include an Ethernet interface, an optical interface, a coaxial interface, a wireless interface, or the like.

Device 200 may perform certain operations described herein. Device 200 may perform these operations in response to processor 220 executing software instructions (e.g., computer program(s)) contained in a computer-readable medium, such as memory 230, a secondary storage device (e.g., a hard disk, etc.), or other forms of random access memory (RAM) or read only memory (ROM). A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

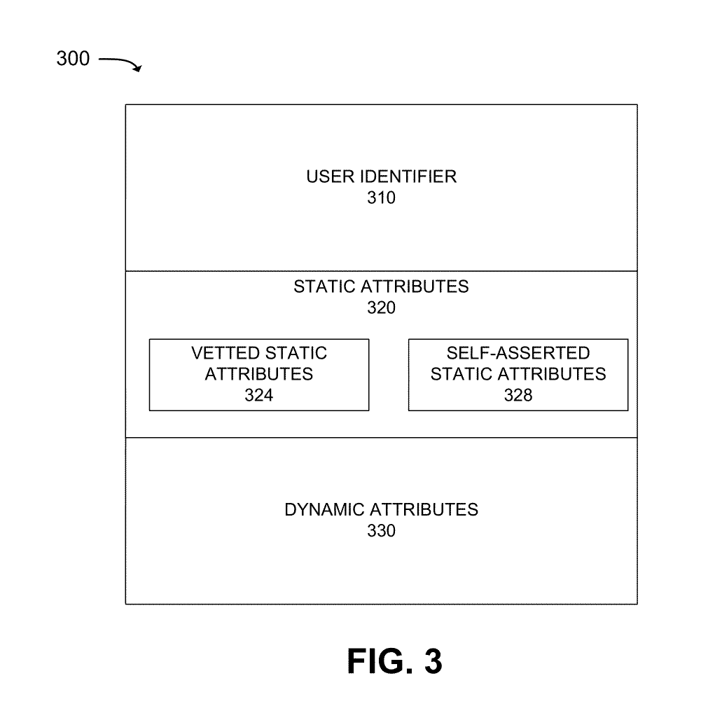

FIG. 3 is a diagram of example information provided in a profile 300 of a user. As shown in FIG. 3, profile 300 may include a user identifier 310, static attributes 320, and dynamic attributes 330. User identifier 310 may include a plurality of characters that uniquely identify a user associated with profile 300.

Static attributes 320 may include information, about the user, that does not change regularly (e.g., a name, a residential address, etc.). As further shown in FIG. 3, static attributes 320 may include vetted static attributes 324 and self-asserted static attributes 328. Vetted static attributes 324 may include static information about the user that attributes server 130 verifies as accurate. Self-asserted static attributes 328 may include static information asserted by the user that is not verified by attributes server 130.

Dynamic attributes 330 may include information about different types of behaviors of the user, such as, for example, shopping information, travel information, etc. Dynamic attributes 330 may change/evolve continuously based on new information about the behaviors. In one example implementation, attributes server 130 may periodically update dynamic attributes 330 based on new information received from data source servers 140.

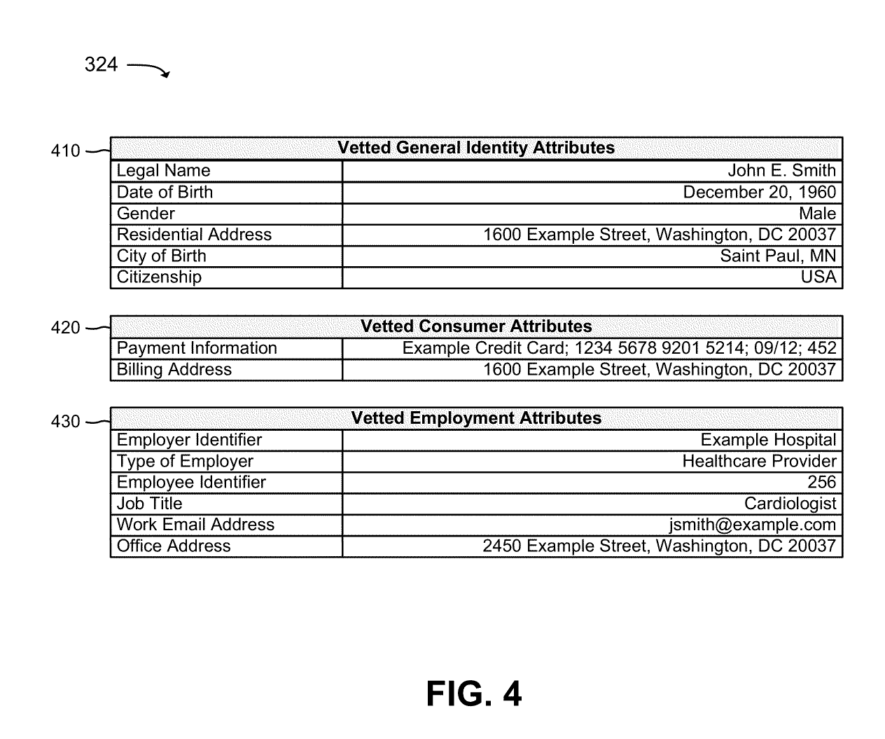

FIG. 4 is a diagram of example vetted static attributes 324. In one example, the user may instruct attributes server 130 to collect and verify different categories of static attributes associated with different personas of the user. As shown in FIG. 4, the different categories may include, for example, vetted general identity attributes 410, vetted consumer attributes 420, and vetted employment attributes 430.

Vetted general identity attributes 410 may include vetted static attributes that are associated with every user. As shown in FIG. 4, vetted general identity attributes 410 may include, for example, a legal name (e.g., John E. Smith), a date of birth (e.g., Dec. 20, 1960), a gender (e.g., Male), a residential address (e.g., 1600 Example Street, Washington, D.C. 20037), a city of birth (Saint Paul, Minn.), and citizenship information (e.g., USA).

Vetted consumer attributes 420 may include attributes that are associated with a user as a consumer of products and/or services. As shown in FIG. 4, consumer attributes 420 may include, for example, account information (e.g., Example Credit Card; 1234 5678 9201 5214; September 2012; 452) and a billing address (e.g., 1600 Example Street, Washington, D.C. 20037).

Vetted employment attributes 430 may include attributes that are associated with a user as an employee. Attributes server 130 may determine which attributes are included in vetted employment attributes 430, for the user, based on an employer of the user. As shown in FIG. 4, employment attributes 430 may include, for example, an employer identifier (e.g., Example Hospital), a type of the employer (e.g., Healthcare Provider), an employee identifier (e.g., 256), a job title (e.g., cardiologist), a work email address (e.g., jsmith@example.com), and an office address (e.g., 2450 Example Street, Washington, D.C. 20037).

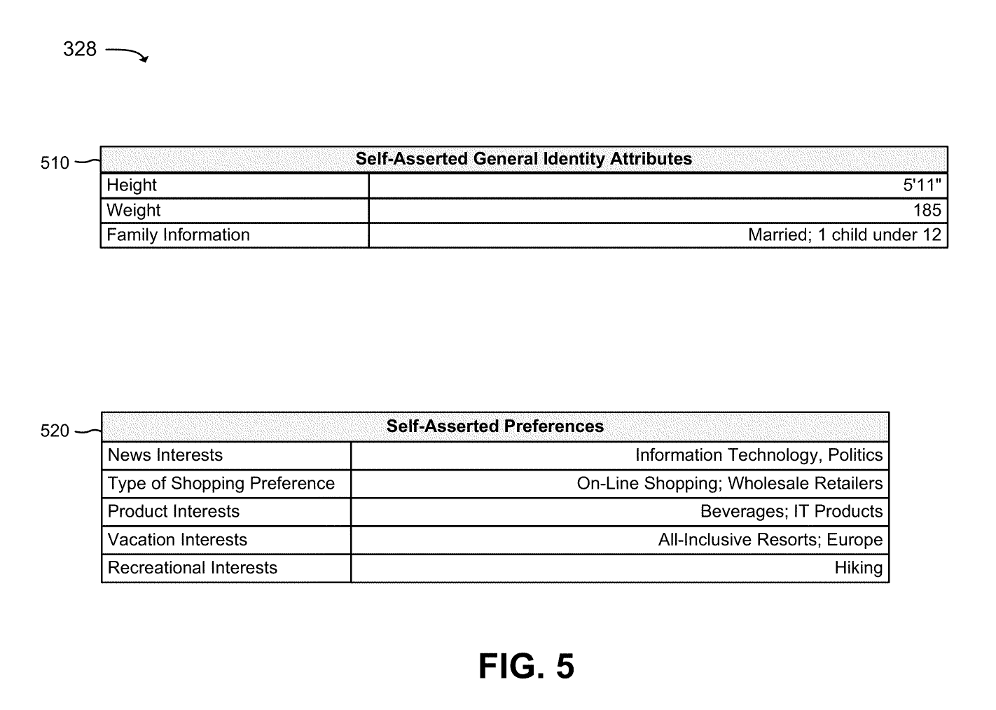

FIG. 5 is a diagram of example self-asserted static attributes 328. As shown in FIG. 5, self-asserted static attributes 328 may include, for example, self-asserted general identity attributes 510 and self-asserted preferences 520.

As further shown in FIG. 5, self-asserted general identity attributes 510 may include demographic information, such as, for example, a height (e.g., 5′ 11″), a weight (e.g., 185), family information (e.g., Married; 2 child under 12), etc. associated with the user. Self-asserted preferences 520 may include, for example, news interests (e.g., Information Technology (IT); Politics), shopping preferences (e.g., online shopping; wholesale retailers), product interests (e.g., beverages; IT products), vacation interests (e.g., all-inclusive resorts; Europe), recreational interests (e.g., hiking), etc. associated with the user.

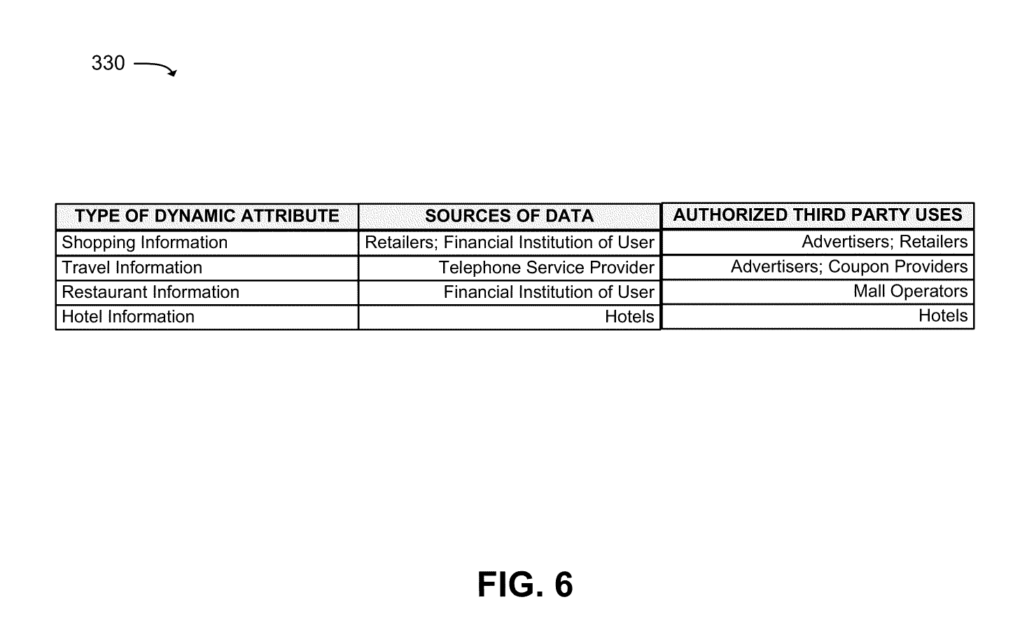

FIG. 6 is a diagram of example dynamic attributes 330. As shown in FIG. 6, dynamic attributes 330 may include, for example, shopping information, travel information, restaurant information, hotel information, etc.

The shopping information may include information about purchases of the user, such as, for example, a name of a retailer, a type of a product, a brand of the product, a price of the product, related saving(s), a type of payment used to purchase the product, and/or any other information associated with the purchase of the product. In one implementation, as shown in FIG. 6, the user may specify that attributes server 130 may receive the shopping information from data source servers 140 of one or more retailers visited by the user, from a financial institution of the user, and/or from other entities. The user may also specify that attributes server 130 is authorized to provide answers, based on the shopping information, to third party servers 120 of advertisers, retailers, and/or other entities.

The travel information may include information associated with locations visited by the user, such as, for example, an address of a location visited by the user, geographic coordinates of the location, a name of a geographic entity (e.g., a name of a city) associated with the location, a time and a day when the user visited the location, and/or any other information associated with the visited location. In one implementation, the user may specify that attributes server 130 may receive the travel information from data source server 140 of a telecommunication service provider associated with user device 110. The user may further specify that attributes server 130 may provide answers, based on the travel information, to third party servers 120 of advertisers, coupon providers, and/or other entities.

The restaurant information may include information associated with restaurants visited by the user, such as, for example, a name of a restaurant, a type of cuisine associated with the restaurant, a price range associated with the restaurant, an amount spent by the user at the restaurant during a visit, information that indicates whether the restaurant is family friendly, and/or any other information associated the restaurant. In one implementation, the user may specify that attributes server 130 may receive the restaurant information from data source server 140 of a financial institution associated with the user. The user may further specify that attributes server 130 may provide answers, based on the restaurant information, to third party servers 120 of shopping mall operators and/or other entities.

The hotel information may include information associated with hotels visited by the user, such as, for example, a name of a hotel, a type of a room in which the user stayed, a price of the room per night, a number of nights during which the user stayed in the room, and/or any other information associated with the hotel. In one implementation, the user may specify that attributes server 130 may receive the hotel information from data source servers 140 of the hotels visited by the user. The user may further specify that attributes server 130 may provide answers, based on the hotel information, to third party servers 120 of hotels and/or other entities.

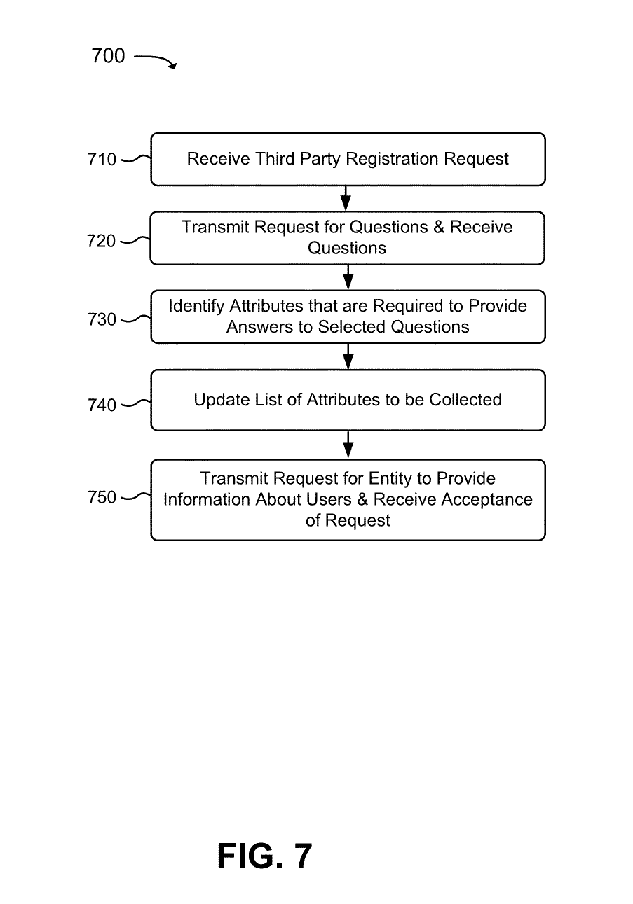

FIG. 7 is a flow chart of an example process 700 for registering a third party server. In one implementation, attributes server 130 may perform process 700. In another implementation, a device or collection of devices separate from, or in combination with, attributes server 130 may perform some or all of process 700.

As shown in FIG. 7, process 700 may include receiving a third party registration request (block 710). In one implementation, a third party may decide to register to receive answers to questions about users, such as a user of user device 110. To register, the third party may use third party server 120 to transmit a third party registration request to attributes server 130. Attributes server 130 may receive the third party registration request. The third party registration request may include information associated with the operator, such as, for example, a type of entity (e.g., a retailer, an advertiser, etc.) associated with the third party.

Process 700 may further include transmitting a request for questions and receiving selected questions (block 720). In one implementation, attributes server 130 may transmit a request for questions to third party server 120. The request for questions may include pre-defined questions that may be asked about users by third party server 120. The third party may use third party server 120 to select one or more of the pre-defined questions. Attributes server 130 may receive the selected questions from third party server 120. Additionally, or alternatively, the request for questions may include instructions for the third party to use a text box to enter one or more questions. The third party may use third party server 120 to enter one or more questions, and attributes server 130 may receive the entered questions.

Process 700 may also include identifying attributes that are required to provide answers to the questions (block 730). In one implementation, attributes server 130 may store rules that indicate which attributes are required for the pre-defined questions. Attributes server 130 may identify the attributes that are required to provide answers to the pre-defined questions based on the rules. For example, assume that the rules indicate that a date of birth is required to provide a first answer to a first question (e.g., “Is the user at least 21 years old?”) of the selected questions. Further assume that the rules indicate that shopping information is required to provide a second answer to a second question (e.g., “What is a name of a retailer that the user is likely to visit?”) of the selected questions. Accordingly, attributes server 130 may identify a static attribute that specifies the date of birth for the first question and a dynamic attribute that specifies the shopping information for the second question.

Alternatively, or additionally, when the received questions include the entered questions, attributes server 130 may perform textual analysis (e.g., optical character recognition (OCR)) of the entered questions to identify the questions and to identify which attributes are required to answer the entered questions. When the textual analysis cannot identify an attribute required to answer a particular question of the entered questions, attributes server 130 may request an operator of attributes server 130 to identify the attribute and to specify how to answer the question based on a value of the attribute. For example, assume that the textual analysis cannot identify an attribute required to answer a particular question (e.g., “Is the user 21?”). The operator of attributes server 130 may identify that the static attribute that specifies the date of birth is required to provide an answer to the question. The operator of attributes server 130 may further specify that the answer to the question is “NO” when a current date is less than twenty-one years before the date of birth of the user, and that the answer to the question is “YES” when the current date is twenty-one or more years before the date of birth of the user.

Process 700 may also include updating a list of attributes to be collected (block 740). In one implementation, attributes server 130 may store a list of attributes that specifies which attributes need to be collected in order to provide answers to questions from third party server 120. Attributes server 130 may determine which ones of the identified attributes are not included in the list. Attributes server 130 may add those attributes to the list.

Process 700 may also include transmitting a request for an entity to provide information about users and receiving an acceptance of the request (block 750). In one implementation, attributes server 130 may transmit, to third party server 120 or to data source server 140 of the third party, a request to provide information about users who visited the third party (e.g., dined at the restaurant of the third party) or used services of the third party (e.g., accepted a coupon of the third party). Attributes server 130 may receive an acceptance of the request from third party server 120 and/or data source server 140. Thereafter, data source server 140, of the third party, may provide the information about the users to attributes server 130.

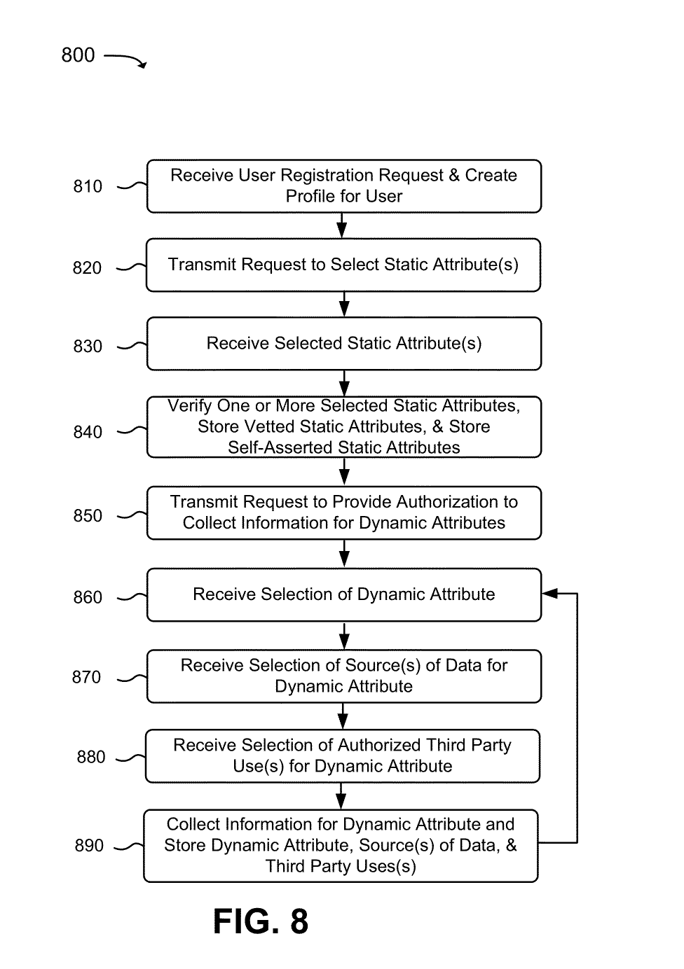

FIG. 8 is a flow chart of an example process 800 for registering a user. In one implementation, attributes server 130 may perform process 800. In another implementation, a device or collection of devices separate from, or in combination with, attributes server 130 may perform some or all of process 800.

As shown in FIG. 8, process 800 may include receiving a user registration request and creating a profile for a user (block 820). In one implementation, a user may decide to register for attributes server 130 to provide answers, to questions about the user, to third parties. To register, the user may use user device 110 to access a registration interface. In one example, the user may access the registration interface via a website provided by an operator of third party server 120, by an operator of attributes server 130, and/or by another entity (e.g., a telephone service provider) associated with the user. Alternatively, or additionally, the user may download a dedicated application to user device 110, and may access the registration interface via the dedicated application.

Attributes server 130 may receive, from user device 110, a user registration request via the registration interface. Attributes server 130 may create profile 300 (FIG. 3) based on the user registration request. Attributes server 130 may determine unique identifier 310 for the user, and may store user identifier 310 in profile 300 (FIG. 3).

Process 800 may further include transmitting a request to select one or more static attributes (block 820) and receiving the one or more selected static attributes (block 830). In one implementation, as discussed above, attributes server 130 may store a list of attributes that are to be collected from users. Attributes server 130 may identify static attributes that are included in the list, and may generate a request for a user to select one or more of the static attributes. Attributes server 130 may transmit the request to user device 110. The user may use user device 110 to select one or more of the static attributes included in the request. User device 110 may transmit the selected static attributes to attributes server 130. The user may also use user device 110 to generate information for each one of the selected static attributes. User device 110 may transmit the information for the selected static attributes to attributes server 130.

Process 800 may also include verifying one or more of the selected static attributes, storing vetted static attributes, and storing self-asserted attributes (block 840). In one implementation, attributes server 130 may identify a first group of the selected static attributes that can be verified by attributes server 130, and may identify a second group of the selected static attributes that cannot be verified by attributes server 130. Attributes server 130 may send requests to one or more data sources 140 to confirm that information, associated with the first group of the selected static attributes, is accurate. Attributes server 130 may verify that the information is accurate when attribute server 130 receives confirmation from data sources 140. In one example, the user may identify an operator of data source server 140 (e.g., a financial institution of the user) that can provide or confirm information used for one of the selected static attributes.

After verifying that the information associated with the first group of the selected attributes is accurate, attributes server 130 may store the first group of the selected static attributes as vetted static attributes 324 in profile 300 (FIG. 3). Attributes server 130 may store the second group of the selected static attributes as self-asserted static attributes 328 in profile 300 (FIG. 3).

Process 800 may also include transmitting a request to provide authorization to collect information for dynamic attributes (block 850). In one implementation, attributes server 130 may identify dynamic attributes that are included in the list of attributes that are to be collected from users. Attributes server 130 may generate a request for the user to provide authorization to collect information for the dynamic attributes. Attributes server 130 may transmit, to user device 110, the request to provide the authorization.

Process 800 may also include receiving a selection of a dynamic attribute (block 860) and receiving a selection of one or more sources of data for the dynamic attribute (block 870). In one implementation, the user may use user device 110 to select one of the dynamic attributes (e.g., shopping information) included in the request. The user may use user device 110 to further select one or more sources of data, such data source server 140, for the selected dynamic attribute. Attributes server 130 may receive, from user device 110, the selected dynamic attribute and the one or more sources of data for the selected dynamic attribute.

In one example, attributes server 130 and/or user device 110 may prompt the user to provide additional information that is required for attributes server 130 to collect information from one or more sources of data. For example, assume that the user selects a financial institution of the user as one of the sources of data. User device 110 may prompt the user to enter account information (e.g., an account number, a personal identification number (PIN), etc.) that is required for attributes server 130 to collect information about the user from data source server 140 of the financial institution. The user may use user device 110 to enter the account information, and attributes server 130 may receive the account information.

Process 800 may also include receiving a selection of authorized third party uses for the dynamic attribute (block 880). In one implementation, the user may use user device 110 to select one or more authorized third party uses for the selected dynamic attribute. For example, the user may select one or more retailers and/or one or more advertisers. As a result, the selection may authorize attributes server 130 to provide answers, based on the selected dynamic attribute, to questions from third party servers 120 that are operated by the selected retailers and/or the selected advertisers. Attributes server 130 may receive the one or more authorized third party uses, for the selected dynamic attribute, from user device 110.

Process 800 may also include collecting the information for the dynamic attribute and storing the dynamic attribute, the sources of data, and the third party uses (block 890). In one implementation, attributes server 130 may transmit instructions to data source server(s) 140 of the one or more sources of data. The instructions may direct data source server(s) 140 to provide information, about the user, for the selected dynamic attribute. Additionally, or alternatively, the instructions may include the account information of the user. Data source server(s) 140 may transmit the information to attributes server 130, and attributes server 130 may receive the information from data source server(s) 140. Attributes server 130 may store the information collected for the selected dynamic attribute, the one or more selected sources of data, and/or the one or more selected authorized third party uses as part of dynamic attributes 330 in profile 300 (FIG. 3).

As further shown in FIG. 8, attributes server 130 may receive selection(s) of one or more other dynamic attributes (block 860), may receive selection(s) of source(s) of data for each one of the other dynamic attributes (block 870), and may receive selection(s) of authorized third party uses for each one of the other dynamic attributes (block 880). Attributes server 130 may collect information for the other dynamic attributes, and may store the information collected for the other dynamic attributes, the selected sources of data for the other dynamic attributes, and the selected third party uses for the other dynamic attributes as part of dynamic attributes 330 in profile 300 (FIG. 3) (block 890).

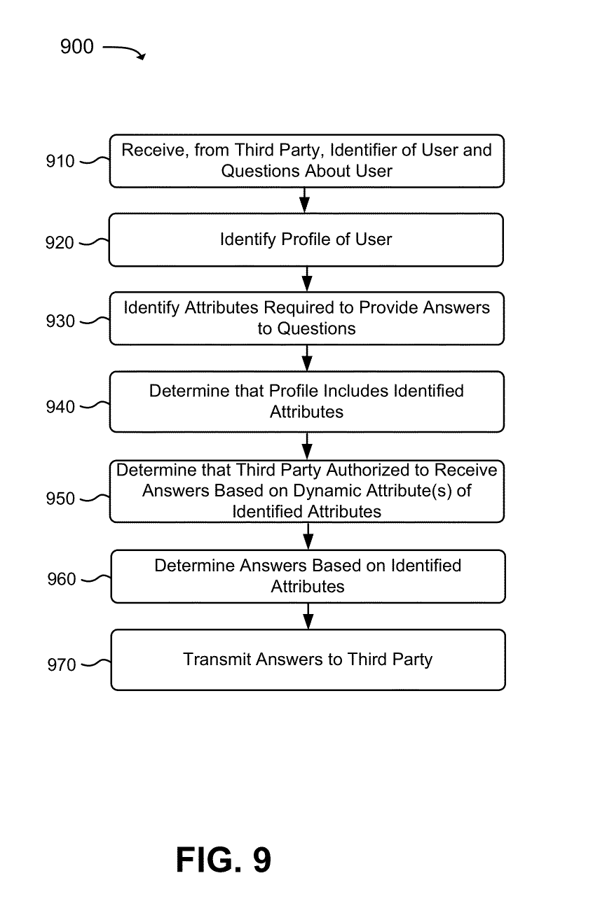

FIG. 9 is a flow chart of an example process 900 for providing answers to questions about a user. In one implementation, attributes server 130 may perform process 900. In another implementation, a device or collection of devices separate from, or in combination with, attributes server 130 may perform some or all of process 900.

As shown in FIG. 9, process 900 may include receiving, from a third party, an identifier of a user and questions about the user (block 910) and identifying a profile of the user (block 920). For example, a third party (e.g., a retailer) may identify a user when the user visits (e.g., shops at a store of) the third party. Assume that the third party wants to provide a targeted offer to the user. The third party may use third party server 120 to enter an identifier (e.g., a credit card number) associated with the user and a request to provide the targeted offer to the user. Third party server 120 may identify, for the targeted offer, one or more questions about the user, including a first question (e.g., Is the user under the age of 30?), a second question (e.g., What type of product is the user most likely to purchase?), a third question (e.g., What is the price range associated with the product that the user is most likely to purchase?), etc. Third party server 120 may transmit the identifier of the user and the questions to attributes server 130. Attributes server 130 may receive, from third party server 120, the identifier and the questions. Attribute server 130 may identify profile 300 (FIG. 3) of the user based on the identifier.

Process 900 may further include identifying attributes required to provide answers to the questions (block 930). For example, attributes server 130 may store rules that indicate which attributes are required to provide answers to which types of questions. Assume that the rules indicate that a particular vetted static attribute that specifies a date of birth is required for the first question and that a particular dynamic attribute that specifies shopping information is required for the second question and the third question. Accordingly, attributes server 130 may identify, based on the rules, the particular vetted static attribute and the particular dynamic attribute(s) for the questions.

Process 900 may also include determining that the profile includes the identified attributes (block 940). For example, attributes server 130 may determine whether vetted static attributes 324, of profile 300, include the particular vetted static attribute and whether dynamic attributes 330, of profile 300, include the particular dynamic attribute(s). Further to the example above, attributes server 130 may determine that vetted static attributes 324 include the particular vetted static attribute because vetted general identity attributes 410 (FIG. 4) include the date of birth of the user. Attributes server 130 may determine that dynamic attributes 330 include the particular dynamic attribute(s) because dynamic attributes 330 include the shopping information (FIG. 6), which includes types of products purchased by the user and prices of those products.

Although not shown in FIG. 9, when attributes server 130 determines that the profile does not include the identified attributes, attributes server 130 may transmit a message to third party server 120. The message may indicate that attributes server 130 cannot provide the answers to the questions because attributes server 130 does not store information, for the user, that is required to answer the questions.

Process 900 may also include determining that the third party is authorized to receive the answers based on the identified attributes (block 950). For example, attributes server 130 may determine whether the third party (e.g., the retailer) is authorized to receive answers based on the particular vetted static attribute. Assume that attributes server 130 received an authorization, from the user, to provide answers based on any one of vetted static attributes 324. Accordingly, attributes server 130 may determine that the third party is allowed to receive answers, based on the particular vetted static attribute, when the particular vetted static attribute is one of vetted static attributes 324.

Furthermore, attributes server 130 may determine whether the third party is authorized to receive answers based on the particular dynamic attribute. With reference to FIG. 6, assume that dynamic attributes 330 include information that indicates that a particular type of third parties (e.g., retailers) are allowed to receive answers based on the particular dynamic attribute (e.g., shopping information). Attributes server 130 may determine a type of the third party (e.g., a retailer). Attributes server 130 may determine that the third party is authorized to receive answers, based on the particular dynamic attribute, when the type of the third party matches the particular type.

Although not shown in FIG. 9, when attributes server 130 determines that the third party is not authorized to receive one or more of the answers based on the identified attributes, attributes server 130 may transmit message to third party server 120. The message may indicate that attributes server 130 cannot provide the answers to the questions because the third party is not authorized to receive one or more of the answers.

Process 900 may also include determining the answers based on the identified attributes (block 960) and transmitting the answers to the third party (block 970). In one implementation, the rules may further indicate how to determine answers based on the questions. Further to the example above, the rules may indicate that a first answer to the first question is “NO” when a current date is less than thirty years before the date of birth specified by the particular vetted static attribute, and that the first answer is “YES” when the current date is thirty or more years after the date of birth of the user. For example, when a current date is Dec. 21, 2011, and the particular vetted static attribute specifies the date of birth of Dec. 20, 1960, attributes server 130 may determine that the first answer is “YES.”

The rules may further indicate that a second answer to the second question is a type of product that is most frequently repeated in the shopping information specified by the particular dynamic attribute. For example, when the particular dynamic attribute indicates that “Electronics” is the most frequently repeated type of product in the shopping information, attributes server 130 may determine that the second answer is “Electronics.”

The rules may also indicate that a third answer to the third question is a range that includes an average of prices of products that are of the most frequently repeated type. For example, when the average of prices of the “Electronics” products, included in the shopping information, is $83.27, attributes server 130 may determine that the third answer is a range of $75.00-$100.00, which includes the average of $83.27.

Attributes server 130 may transmit the first answer, the second answer, and the third answer to third party server 130. Third party server 130 may select a product, offered by the third party, based on the first answer, the second answer, and the third answer. For example, third party server 130 may select an electronic toothbrush that is being sold for $95.00 and is mostly purchased by people who are over the age of 30. Third party server 130 may generate a targeted offer for the electronic toothbrush, and may display the targeted offer to the third party. The third party may provide the targeted offer to the user.

FIG. 10 is a flow chart of an example process 1000 for providing a targeted offer. In one implementation, attributes server 130 may perform process 1000. In another implementation, a device or collection of devices separate from, or in combination with, attributes server 130 may perform some or all of process 1000.

As shown in FIG. 10, process 1000 may include receiving, from a third party, a request to provide a targeted offer to a user (block 1010). For example, assume that a third party (e.g., a coupon provider) wants to provide a targeted offer (e.g., a coupon for lunch at a Mexican restaurant in Fairfax, Va.) to a user. The third party may use third party server 120 to generate a request to provide the targeted offer. The request may include the targeted offer and characteristics of the user. The characteristics may include a first characteristic that specifies that that the user visits Fairfax, Va., between 11:00 AM and 2:00 PM, and a second characteristic that specifies that the user visits restaurants with that serve Mexican cuisine. Third party server 120 may transmit the request to attributes server 130, and attributes server 130 may receive the request.

Process 1000 may further include determining types of attributes associated with the characteristics that are included in the request (block 1020). For example, attributes server 130 may determine that a first dynamic attribute, which specifies travel information, is associated with the first characteristic included in the request. Attributes server 130 may further determine that a second dynamic attribute, which specifies restaurant information, is associated with the second characteristic included in the request.

Process 1000 may also include identifying a profile that includes the types of the attributes (block 1030). In one implementation, attributes server 130 may identify profile 300 (FIG. 3) that includes the first dynamic attribute (e.g., travel information) and the second dynamic attribute (e.g., restaurant information) as part of dynamic attributes 330 (FIG. 3).

Process 1000 may also include determining that information specified by the attributes in the profile matches the characteristics (block 1040). In one implementation, attributes server 130 may determine that information specified by the first dynamic attribute (e.g., the travel information), of profile 300, indicates that the user has visited Fairfax, Va., between 11:00 AM and 2:00 PM. Furthermore, attributes server 130 may determine that information specified by the second dynamic attribute, of profile 300, indicates that the user visited a restaurant that serves Mexican cuisine. As a result, attributes server 130 may determine that the information specified by the first dynamic attribute matches the first characteristic, and that the information specified by the second dynamic attribute matches the second characteristic.

Process 1000 may also include identifying contact information of the user in the profile (block 1050) and providing the targeted offer to the user (block 1060). In one implementation, when attributes server 130 determines that the information specified by the attributes in profile 300 matches the characteristics, attributes server 130 may identify contact information of the user in profile 300. In one example, the contact information may include a telephone number of user device 110, which may be included in static attributes 320 of profile 300 (FIG. 3). Attributes server 130 may send, by using the telephone number, a text message to user device 110 that includes the targeted offer. In another example, the contact information may include an email address of the user, which may be included in static attributes 320 of profile 300 (FIG. 3). Attributes server 130 may send, by using the email address, an email to the user that includes the targeted offer.

In one implementation, systems and/or methods described herein may allow attributes server 130 to provide answers, based on information about a behavior of a user, in response to questions from third party server 120. The answers may not include any data that applies only to the user. Alternatively, or additionally, systems and/or methods described herein may allow attributes server 130 to provide, in response to a request from third party server 130, a targeted offer to the user based on the information about the behavior of the user. As result, third party server 120 may not need access to the information about the behavior of the user in order to provide the targeted offer to the user.

The foregoing description provides illustration and description, but is not intended to be exhaustive or to limit the embodiments to the precise form disclosed. Modifications and variations are possible in light of the above teachings or may be acquired from practice of the embodiments.

While series of blocks have been described with regard to FIGS. 7-10, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a server device, authorization to collect information about a behavior of a user from a data source;
collecting, by the server device, the information from the data source;
receiving, by the server device and from a third party device, a question about the user;
determining, by the server device, whether the third party device is authorized to receive an answer, to the question, based on the collected information;
determining, by the server device, the answer based on the information when the third party device is authorized to receive the answer,
where the answer does not include any data that identifies the user; and
transmitting, by the server device, the answer to the third party device.

2. The method of claim 1, where the information comprises one or more of:
information associated with a visit to a geographic location by the user, or
information associated with a visit to a service provider by the user.

3. The method of claim 1,
where the third party device is associated with one of:
a retailer,
service provider,
an advertiser, or
a coupon provider, and
where the third party device provides an offer, targeted to the user, based on the answer.

4. The method of claim 1,
where receiving the authorization to collect the information about the behavior comprises:
receiving an authorization to provide answers, based on the information, to a particular type of third party devices, and
where determining whether the third party device is authorized to receive the answer comprises:
determining a type of the third party device, and
determining that the third party device is authorized to receive the answer when the type matches the particular type.

5. The method of claim 1, where collecting the information from the data source comprises:
transmitting, to the data source, instructions to provide the information, and
receiving the information from the data source based on the instructions.

6. The method of claim 5,
where, when the data source is a financial institution, receiving the authorization to collect the information about the behavior comprises:
receiving financial account information associated with the user, and
where the instructions comprise the financial account information.

7. The method of claim 1, where receiving the authorization to collect the information about the behavior comprises:
transmitting, to the third party device, pre-defined questions, where the question is one of the pre-defined questions,
receiving, from the third party device, a selection of the question from the pre-defined questions,
identifying a type of the information required to provide the answer to the question,
transmitting, to a user device associated with the user, a request to provide the authorization to collect the information, and
receiving, from the user device, the authorization to collect the information in response to the request to provide the authorization.

8. A server device comprising:
a processor to:
receive authorization to collect information about a behavior of a user from a data source,
collect the information from the data source,
receive, from a third party device, a request to provide an offer to the user, where the request to provide the offer comprises one or more characteristics,
determine whether the information specifies the one or more characteristics,
identify contact information of the user when the information specifies the one or more characteristics, and
provide the contact information to the third party device, where the third party device provides the offer to a user device, associated with the user, based on the contact information.

9. The server device of claim 8, where the information comprises one or more of:
information associated with geographic locations visited by the user, or
information associated with service providers visited by the user.

10. The server device of claim 8,
where the offer is one or more of:
an advertisement, or
a coupon, and
where the third party device is associated with one or more of:
a retailer,
a service provider,
an advertiser, or
a coupon provider.

11. The server device of claim 8,
where the characteristics specify one or more of:
a geographical location,
a time period, or
a type of entity associated with the offer, and
where, when determining whether the information specifies the one or more characteristics, the processor is further to:
determine that the information specifies the one or more characteristics when the information indicates that the user visited the geographical location during the time period and that the user visited the type of entity.

12. The server device of claim 8, where, when collecting the information from the data source, the processor is further to:
transmit, to the data source, instructions to provide the information, and
receive the information from the data source based on the instructions.

13. The server device of claim 8,
where, when the data source is a financial institution, and when receiving the authorization to collect the information, the processor is further to:
receive financial account information associated with the user, and where the instructions comprise the account information.

14. A computer-readable medium, comprising:
one or more instructions that, when executed by one or more processors of a device, cause the one or more processors to:
receive, from a third party device, a question about a behavior of a user,
identify an attribute required to provide an answer to the question,
determine whether a profile of the user includes the attribute,
determine the answer based on the attribute when the profile includes the attribute,
where the answer does not include any data that identifies the user, and provide the answer to the third party.

15. The computer-readable medium of claim 14, further comprising:
one or more instructions that, when executed by the one or more processors of the device, cause the one or more processors to:
receive authorization to collect information, for the attribute, from a data source,
collect the information from the data source based on the authorization, and
store the collected information in the profile as the attribute.

16. The computer-readable medium of claim 14, further comprising:
one or more instructions that, when executed by the one or more processors of the device, cause the one or more processors to:
receive authorization to provide answers, based on the attribute, to a particular type of third party devices,
determine, after receiving the question, a type of the third party device, and
determine that the third party device is authorized to receive the answer when the type matches the particular type.

17. The computer-readable medium of claim 14, where the attribute comprises one or more of:
information associated with geographic locations visited by the user,
information associated with merchants visited by the user.

18. The computer-readable medium of claim 14,
where the third party device is associated with one of:
a retailer,
an advertiser, or
a coupon provider, and
where the third party device provides a targeted offer to the user based on the answer.

19. The computer-readable medium of claim 14, further comprising:
one or more instructions that, when executed by the one or more processors of the device, cause the one or more processors to:
transmit, to the third party device, pre-defined questions, where the question is one of the pre-defined questions,
receive, from the third party device, a selection of the question from the pre-defined questions,
determine that the attribute is required to provide the answer to the question,
transmit, to a user device associated with the user, a request to provide the authorization to collect information for the attribute, and
receive, from the user device and based on the request, the authorization to collect the information from a data source.

20. The computer-readable medium of claim 19, further comprising:
one or more instructions that, when executed by the one or more processors of the device, cause the one or more processors to:
transmit, to the data source, instructions to provide the information,
receive the information from the data source based on the instructions, and
store the information in the profile as the attribute.
